(19) United States
(12) Patent Application Publication
(10) Pub. No.: US 2007/0170293 A1
(43) Pub. Date: Jul. 26, 2007

(54) Method for unpacking a paper reel and device for carrying out the method

(75) Inventors: Oliver Colombo, Roschenz (CH); Louis Hulmann, Saulcy (CH); Christophe Weber, Delemont (CH)

Correspondence Address: OLIFF & BERRIDGE, PLC, P.O. BOX 19928, ALEXANDRIA, VA, 22320, US

(73) Assignee: METSO PAPER AG, DELEMONT (CH)

(21) Appl. No.: 11/656,975

(22) Filed: Jan. 24, 2007

(30) Foreign Application Priority Data
Jan. 24, 2006 (EP) 06 405 032.1

(51) Int. Cl. A01K 89/00

(52) U.S. Cl. 242/319

(57) ABSTRACT

A cutting apparatus (7) fixed to a robot arm and intended for separating off end parts of the packaging of a paper reel comprises an edge cutting unit (7) having an edge cutting disc (18) and a detector (19), and a positioning unit (16) having an elastic positioning strip (27) which is wound on a winding roller (26) and which is unwound after piercing an end part by means of a spindle (33) and is pushed at the spindle (33) between the end part and an end face of the paper reel and up to the edge of the end face and is passed through the circumferential packaging. The edge cutting unit (17) is then positioned as a function of the position of the tip of the positioning strip (27) determined by the detector (19) and is advanced, whereupon the edge cutting disc (18) makes an all-round cut just behind the end part with rotation of the paper reel, and the end part is clamped between gripper arms (20a, b) and a clamping arm (22) and is removed. A separation apparatus for cutting open a lateral part of the packaging has a pre-cutting disc for reducing the pressure on a plough which then cuts open the remaining outermost layers.

### FIELD OF THE INVENTION

The invention relates to a method for unpacking a paper reel, as carried out in reel cellars of printing works in the course of the preparation of paper reels for use. It also relates to a device for carrying out the method.

### Prior Art

Paper reels as used in printing works are delivered in packaging which usually comprises cardboard end labels and a circumferential covering comprising a plurality of turns of packaging paper which is usually folded inwards over the edges of the end labels and adhesively bonded to the end labels. The circumferential covering is also often adhesively bonded to the outer layers of the paper reel. During unpacking, as a rule the end parts of the packaging, consisting of the end labels and those parts of the circumferential covering which are adhesively bonded to it, are first separated off and removed. Thereafter, the remaining lateral part of the circumferential covering is cut open and unwound and likewise removed.

The separation and removal of the end part can be effected manually. However, automatic methods and corresponding devices for carrying them out are also known. Thus, EP 0 592 845 A1 describes a method of the generic type in which, after the centre of the end face has been found, a spindle is inserted through the end part of the packaging into the interior of the cardboard core on which the paper roll is wound and said spindle is then withdrawn. In the central opening thus produced, a side knife is then mounted and is guided along the end face to a starting position at the edge thereof, a radial cut being made through the end part. Thereafter, the paper reel is turned and the end part is separated off by a circumferential cut starting from the starting position and running along the edge of the end face by means of the side knife.

In this method, the time requirement is increased by the essentially unnecessary radial cut which serves especially for positioning the side knife for the circumferential cut. The device of the generic type which is used for carrying out the method, especially concerning the side knife and its guidance, which must permit both a radial and circumferential cut, is relatively complicated and expensive.

According to JP 1997-207-923 A, the end part is removed by making a spiral cut starting from the centre of the end face. This too, requires a relatively long time, especially since the paper reel has to execute a plurality of revolutions.

After removal of the end parts on an end face of the paper reel, the lateral part of the packaging is removed according to EP 0 592 845 A1. For this purpose, the tip of a separating part in the form of a plough is introduced under the lateral part, said separating part being raised slightly beforehand from the paper reel by a friction brush pressing elastically against the edge of the end face, and the radial position of the separating part being determined by a support roller rolling on the lateral part. The separating part is then drawn parallel to the reel axis to the opposite end face, the layers located outside thereof being cut through. The separating part is positioned so that, in addition to the lateral part of the packaging, it also cuts through some outer layers of paper, which are often damaged and the outermost layers of which are adhesively bonded to the mantle.

Owing to the high pressure which the firm lateral part of the packaging exerts on the separating part, the boundary layer over which said separating part is drawn and which forms the outermost layer of the unpacked paper reel and layers adjacent to this may easily be damaged, in particular slightly pressed in. The insertion of the tip of the separating part into the compact paper reel requires a great deal of force and can easily lead to damage to the paper. Adjusting the position of the separating part so that damage to the paper is reliably ruled out is difficult, especially if the lateral part of the packaging is adhesively bonded to the outer layers of the paper reel and it is not possible to raise said lateral part from the reel.

Similar methods are known which use a wedge-like separating part which carries, on the outside, a rotating cutting disc which cuts through the mantle, cf. for example EP 0 959 009 A1 or JP 1997-207 923 A. This can slightly reduce the pressure on the separating part during the further course of cutting open the mantle, but the difficulties are not overcome thereby and in particular the insertion of the tip is not facilitated.

EP 0 792 813 A1 discloses a method in which a separating part in the form of a ploughshare is used with an elongated sliding plate which carries on the outside a blade perpendicular to the sliding plate and having a cutting edge, and a cutting disc which is located downstream in the cutting direction and arranged between runners beyond which they project only slightly and which cut open one or two further layers behind the separating part. Once again, the difficulties described are however not eliminated thereby.

### SUMMARY OF THE INVENTION

It is the object of the invention to improve the known method of the generic type so that the removal of the end parts can be carried out quickly and reliably by relatively simple means. Moreover, it is intended to provide a device which is suitable for carrying out the method, has a relatively simple design and is therefore economical.

These objects are achieved by the features in the characterizing clause of claims 1 and 29, respectively. The advantages achievable by the invention are in particular that the method is simple, in particular comprises no cuts or other measures which in principle are unnecessary and nevertheless takes place with great reliability. The device according to the invention has a simple design and is economical, especially since substantial parts can be brought ready-made, while it is otherwise possible to manage with relatively simple components. It also has very high operational reliability.

In the method according to the invention, according to claim 11, the lateral part of the packaging is also cut open and removed. This and possibly also some outer layers of the paper reel are cut through by a preliminary cut before the remaining outer layers are broken open by the separating part. The pressure acting on the separating part is substantially reduced thereby. The danger of damage to the boundary layer over which the sliding surface of the separating part is guided and further layers located directly within said boundary layer is greatly reduced. The introduction of the tip of the separating part is also substantially facilitated since the paper reel is less firm in the region of the insertion point and less resistance is offered to the penetration of the tip.

A device which is also suitable for cutting open the lateral part can preferably have the form according to claim 39.

### BRIEF DESCRIPTION OF THE DRAWINGS

The invention is explained in more detail below with reference to figures which represent only one working example.

FIG. 1 shows a plan view of the unpacking device according to the invention,

FIG. 2 shows a cutting apparatus of the unpacking device according to the invention, according to FIG. 1, obliquely from the top front,

FIG. 3 shows a positioning unit of the cutting apparatus of FIG. 2,

FIG. 4 shows a section through the positioning unit of FIG. 3 and a part of the paper reel in a first phase of separating off the end part,

FIG. 5 shows a plan view of the positioning unit and a part of the paper reel in a second phase of separating off the end part,

FIG. 6 shows, on a larger scale, a section through that part of the paper reel which is adjacent to the edge of the end face, during the second phase of separating off the end part,

FIG. 7 shows a side view of a part of an edge cutting unit of the cutting apparatus of FIG. 2 with a part of the paper reel during a third phase of separating off the end part,

FIG. 8 shows a plan view, partly cut away, corresponding to FIG. 7,

FIG. 9 shows a side view of the edge cutting unit during a fourth phase of separating off the end part,

FIG. 10 shows a side view of the edge cutting unit during a fifth phase of separating off the end part,

FIG. 11 shows a plan view, partly cut away, corresponding to FIG. 10,

FIG. 12 shows a plan view of a separating apparatus of the device according to the invention,

FIG. 13 shows substantially a section through the separating apparatus according to XIII-XIII in FIG. 12,

FIG. 14 shows a cut-out of a plan view of the separating apparatus and a part of the paper reel during a first phase of cutting open the lateral part of the packaging,

FIG. 15 shows a cut-out similar to FIG. 14 during a second phase of cutting open the lateral part,

FIG. 16 shows a cut-out similar to FIG. 14 during a third phase of cutting open the lateral part,

FIG. 17 shows a cut-out similar to FIG. 14 during a fourth phase of cutting open the lateral part,

FIG. 18 shows a plan view of a separating apparatus of a device according to the invention, according to a further embodiment, and

FIG. 19 shows a side view of the separating apparatus according to FIG. 18.

### DESCRIPTION OF THE PREFERRED EMBODIMENTS

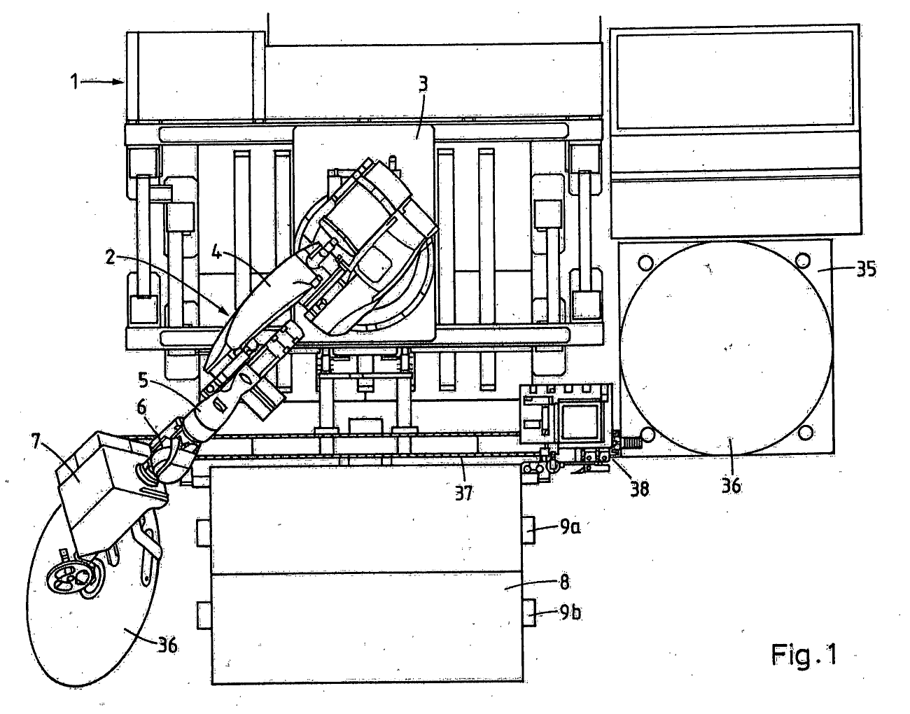

The unpacking device comprises (FIG. 1) a base frame 1 of approximately rectangular contour, the top of which carries a multiaxial robot arm 2 arranged centrally in the longitudinal direction of the base frame 1. It has a base 3 which is mounted on the base frame 1 so as to be rotatable about a vertical pivot axis and carries a first pivot arm 4 which is tiltable about a horizontal pivot axis and to the outer end of which a second pivot arm 5 is connected so as to be tiltable about a horizontal transverse axis and rotatable about a longitudinal axis. The pivot arm 5 carries a cutting apparatus 7 on its outer end via a joint 6 which permits a tilting movement about a further transverse axis.

A support device for receiving a packed paper reel 8 is arranged before the base frame 1, with two horizontal rolls 9a, 9b which are parallel to the longitudinal direction of the base frame 1 and arranged side by side and a distance apart and one of which can be driven so that the packed paper reel 8 can be rotated about its axis parallel to the rolls 9a, b.

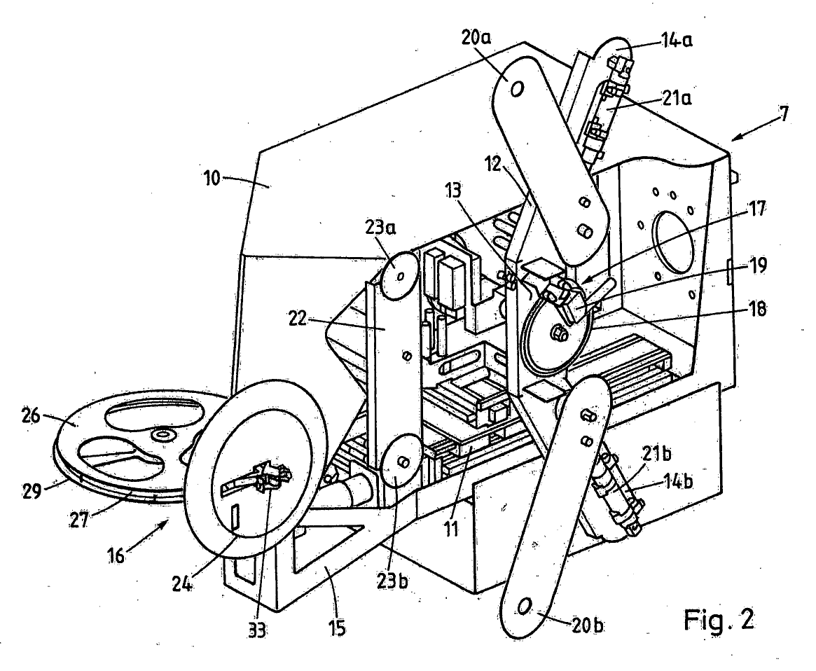

In a housing 10 (FIG. 2) of the cutting apparatus 7, which is open at its front pointing in a direction opposite to the longitudinal direction of the base frame 1 when in use, a carriage 11 is mounted so as to be displaceable in a longitudinal direction of the housing 10 and carries a support profile 12 which can be moved back and forth transversely thereto and has a middle piece 13 and extensions 14a, b projecting obliquely upwards and downwards. A positioning unit 16 is fixed at the end of a boom 15 of the housing 10 in the continuation of the open front.

The middle piece 13 of the support profile 12 carries an edge cutting unit 17 which comprises a knife which is in the form of a drivable edge cutting disc 18. The edge cutting disc 18 is arranged in front of a detector 19 which is supported-above said edge cutting disc on the middle piece 13 and is preferably in the form of an optical sensor but may also be a magnetic, electrical or mechanical sensor. On the extensions 14a, b, two flat plate-like gripper arms 20a, b of a gripper unit are mounted so as to be pivotable about gripper axes oriented in a transverse direction of the housing 10 running transversely to its longitudinal direction. Two pneumatic pistons 21a; b supported on the end regions of the extensions 14a; b serve for pivoting the gripper arms 20a, b. An elongated plate-like clamping arm 22 which carries two projecting clamping rams 23a, b arranged one above the other is mounted on a boom of the carriage 11 as a further part of the gripper unit so as to be displaceable back and forth in the transverse direction.

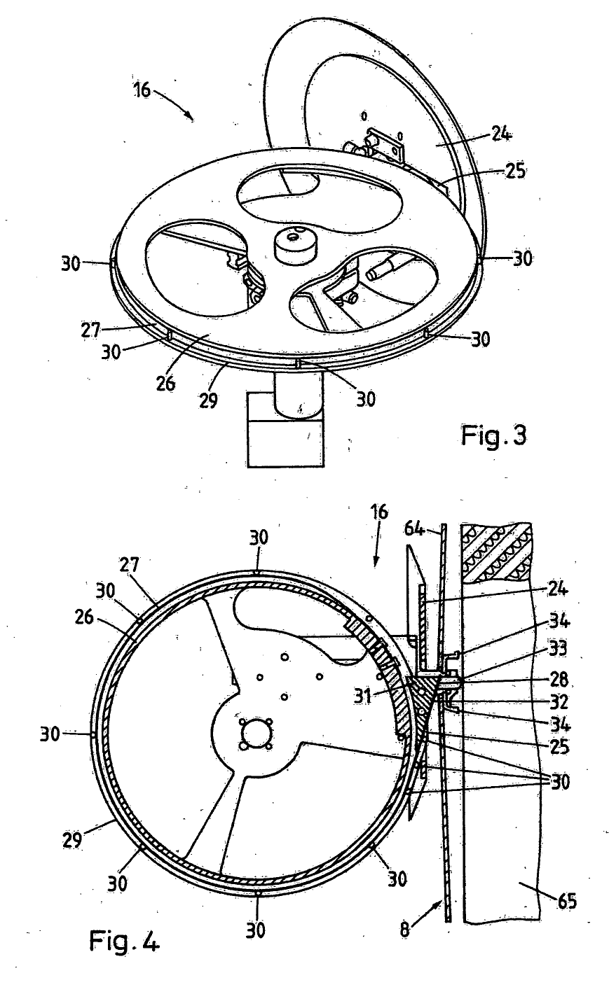

The positioning unit 16 comprises (cf. also FIG. 3, 4) a flat round shield 24 which makes a right angle with the transverse direction and is penetrated by a radial slot 25 which widens in the region of the midpoint. Behind the shield 24, a drivable winding roller 26 is mounted so as to be rotatable about a winding axis normal to the longitudinal direction and transverse direction. It carries a positioning strip 27 of elastic material, e.g. spring steel, which is straight in the relaxed state but is bent elastically around the winding roller 26 in an approximately circular or spiral manner in a rest position. The tip 28 of the positioning strip 27 forms a fix which can be located by the sensor 19. The positing strip 27 is anchored at two points a distance apart in the longitudinal direction, in the region of its rear end, on the outside of the winding roller 26.

A slightly larger non-rotatable reel 29 arranged directly below the winding roller 26 carries a plurality of guide pins 30 which are distributed over its circumference and hold the positioning strip 27, the outside of which touches it, in the rest position. In the region of the slot 25, a plurality of guide pins 30, three in the example, are arranged in succession in a straight line which passes obliquely through the slot 25. A wedge 31 projecting slightly through said slot forms a straight guide strip 32 which is offset slightly backwards relative to said line and is parallel to it. The positioning strip 27 can be unwound in the counter-clockwise direction by rotation of the winding roller 26 and can be advanced to a position of use along the guide pins 30 and finally the guide strip 32 and can be retracted to the rest position by rotation of the winding roller 26 in the clockwise direction.

A spindle 33 projects in the middle of the shield 24 through the slot 25 forwards in a transverse direction. It is formed by two parallel elongated plates between which the wedge 31 projects and between which the positioning strip 27 can be pushed through along the guide strip 32. In the end region of the spindle 33, driver fingers 34 which can be actuated via two belts by means of a pneumatic piston are mounted in a laterally spreadable manner between the plates.

In addition to the base frame 1, a stacking basket 35 for end parts 36 which have been cut off is arranged (FIG. 1) within range of the robot arm 2.

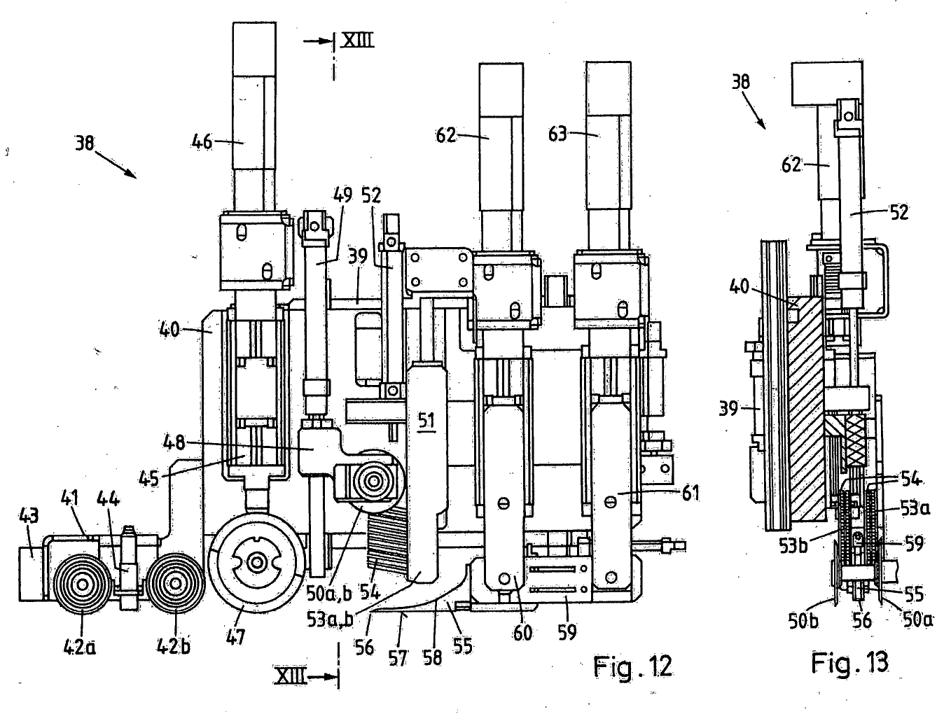

The unpacking device furthermore has (FIG. 1) a rail 37 which is oriented in the longitudinal direction on the base frame 1 and mounted so as to be advancable towards the receiving device and retractable from it. Along the rail 37, a separating apparatus 38 can be moved in a separation direction corresponding to the longitudinal direction of the base frame 1 and can be retracted in a direction opposite to said direction, for example by means of a drivable closed belt. It serves for cutting open the lateral part of the packaging of the paper reel 8 along a parting line which follows a straight generating line. The separating apparatus 38 comprises (FIG. 12, 13) a carriage 39 which is mounted on the rail 37 and carries a baseplate 40 which can be advanced and retracted by means of a first pneumatic piston (not shown) in a transverse direction of the base frame 1 which is normal to its longitudinal direction and points approximately towards the axis of the paper reel. Mounted directly on the base plate 40 at the front in the direction of movement is a scanning unit 41 having, in succession in the direction of movement, two support rollers 42a, b which are rotatable about axes perpendicular to the longitudinal direction and to the transverse direction and a mantle sensor 43, for example an optical mantle sensor 43, arranged upstream of the first roller 42a, and a distance sensor 44 for example an optical distance sensor 44, arranged between the rollers 42a, b.

Mounted on the baseplate 40 are a plurality of successive carriers which carry different tools and, independently of one another, can be advanced and retracted by means of pneumatic or electric drives parallel to the transverse direction, in which the base plate 40 too is displaceable, relative to said baseplate. A carrier 45 which is at the front in the direction of movement and is displaceable in the transverse-direction by means of an electric drive 46 carries a pre-cutting disc 47 which is fixed on a drivable axle which is mounted in the carrier 45 and is parallel to the axes of the support rollers 42a, b.

Two cutting discs 50a, b for loosening purposes, which are a distance apart laterally, i.e. normal to the longitudinal direction and transverse direction, are mounted on a further carrier 48, which can be actuated by means of a pneumatic piston 49, so as to be rotatable about a drivable axis likewise parallel to the axes of the support rollers 42a, b. A subsequent carrier 51, which can be actuated by a pneumatic piston 52, carries two brushes 53a, b which are arranged side by side and a distance apart and have bristles 54 which project in the separation direction but with slight inclination relative to the baseplate 40 and the ends of which form a friction surface.

Provided as a separating part is a plough 55 having a tip 56 projecting in the separation direction and a sliding surface 57 normal to the transverse direction, i.e. pointing approximately towards the axis of the paper reel, and, on the opposite side, a hump 58 which runs from the tip 56 in a direction opposite to the separation direction and, following a concave line, becomes increasingly removed from the sliding surface 57. The plough 55 is fixed to a beam-like holder 59 which in turn is connected in an articulated and springy manner to two parallel carriers 60, 61 which are a distance apart in the separation direction and can be moved independently of one another by pneumatic pistons 62, 63 so that an inclination of the plough 55 relative to the separation direction can also be set.

The two brushes 53a, b are arranged laterally on both sides of and close to the tip 56 of the plough 55, beyond which they project slightly in the separation direction. Two cutting wheels 50a, b for loosening purposes are located somewhat further outside and their axes are located just behind the ends of the brushes in the separation direction when these are not compressed. This lateral offset relative to the tip 56 located centrally between them is, for example, 20 mm. It may also assume other values which are preferably between 10 mm and 40 mm.

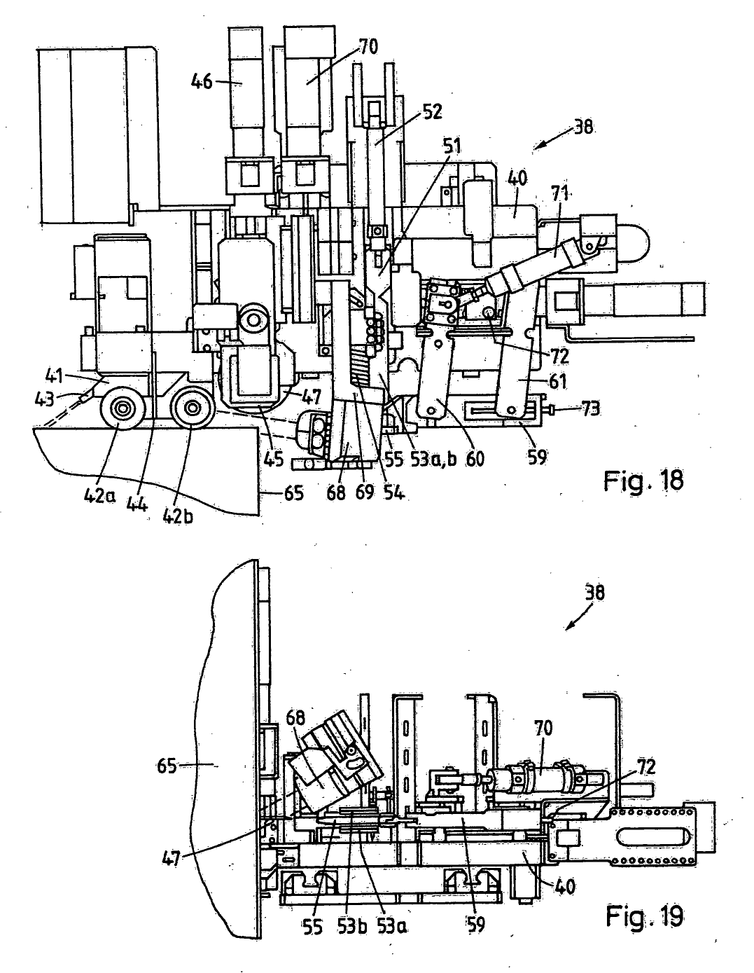

According to a further embodiment, the separation apparatus 38 is formed differently in detail (FIG. 18, 19). It comprises an electronic camera 68 which is fixed to a carrier 69 which is mounted on the baseplate 40 so as to be displaceable in the transverse direction by means of an electric drive 70. The camera 68 which is arranged approximately next to the plough 55 and to which a lamp for illuminating the field of view is fixed is oriented approximately in the separation direction, not exactly but slightly obliquely thereto. It may be a camera of the Cognex brand, which can be obtained from Akatech, CH-1024 Ecublens. The carriers 61, 62 from which the holder 59 of the plough 55 is suspended are pivotably anchored on the baseplate 40 so that they form a parallelogram suspension. They are held by a pneumatic piston 71 in a position in which the plough is slightly advanced and from which it can be pushed back against the elastic resistance of the pneumatic piston 71 until the carrier 60 comes up against a stop 72. The inclination of the lough 55 relative to the separation direction can be fixed manually by means of a set screw 73 by moving the point of attachment of the carrier 61 to the holder 59 of the plough 55. The brushes 53a, b are additionally equipped with compressed-air nozzles which are arranged between the bristles 54 and are suitable for releasing a compressed air pulse approximately parallel thereto. No cutting discs for loosening purposes are provided.

The unpacking of a packed paper reel 8 is carried out fully automatically by the device described. For this purpose, said paper reel is placed on the rolls 9a, b (FIG. 1) so that its axis is parallel to the longitudinal direction. The packaging consists of, cardboard end labels 64 (FIG. 6), which cover the end faces of the paper reel 65 (without packaging) wound from white paper, and a circumferential packaging 66 of darker, usually brown, packaging paper, which is wound around the paper reel 65 and forms one layer or usually a plurality of layers there and is adhesively bonded to the outer paper layers. Edge strips of the circumferential packaging 66 are usually folded onto the outsides of the end labels 64, where they cover an outer ring and are adhesively bonded to it.

The end part of the packaging, on the right in FIG. 1, is first removed. For this purpose, the cutting apparatus 7 is moved by means of the robot arm 2 adjacent to the packed paper reel 8 in such a way that the open side of the housing 10 faces the end face thereof. The cutting apparatus 7 is then moved parallel to the axis of the packed paper reel 8, approximately towards the centre of the end face thereof, until the spindle 33 with driver fingers 34 folded forwards comes up against the end label 64 and penetrates it. The driver fingers 34 are then folded back so that they project laterally and the cutting apparatus 7 is drawn back slightly in the longitudinal direction so that a gap forms there between the end face of the paper reel 65 and the end label 64 (FIG. 4).

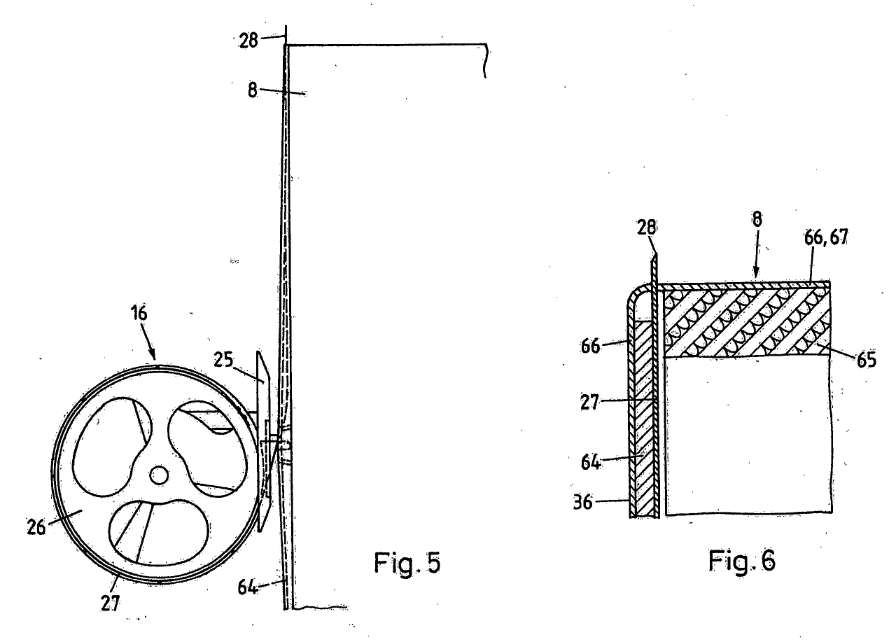

Thereafter, the winding roller 26 is rotated slowly in the counter-clockwise direction and the positioning strip 27 is unwound and its tip 28 is advanced, first along the guide strip 32 and then further within the end label 64 towards the end face of the paper reel 65, against which it scrapes. Furthermore, it is moved radially outwards along the end face while the following part of the positioning strip 27 rests against the end face. Finally, it reaches the edge of the end label 64 and penetrates the circumferential packaging below said end label so that the tip 28 reaches a locating position where it projects somewhat beyond the circumferential packaging 66 (FIG. 5, 6).

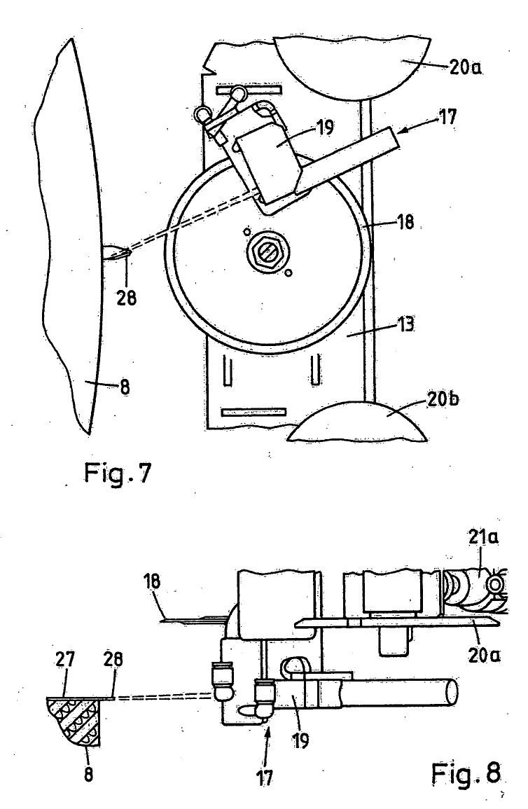

Thereafter, the detector 19 is activated (FIG. 7, 8) and the support profile 12 is advanced in the longitudinal direction towards the packed paper reel 8 until the detector 19 detects the tip 28 as a fix, whereupon the feed is continued exactly by the known distance between this and the edge cutting disc 18 and is then stopped. The edge cutting disc 18 is then fed by advancing the carriage 11 in the transverse direction, i.e. towards the packed paper reel 8, until it penetrates slightly into the circumferential packaging 66 and between the end face of the paper reel 65 and the end label 64. It can be moved along with mechanical contact on the tip 28, the contact being monitored, for example, electrically. Finally, the winding roller 26 is rotated in the clockwise direction and the positioning strip 27 is wound thereon again.

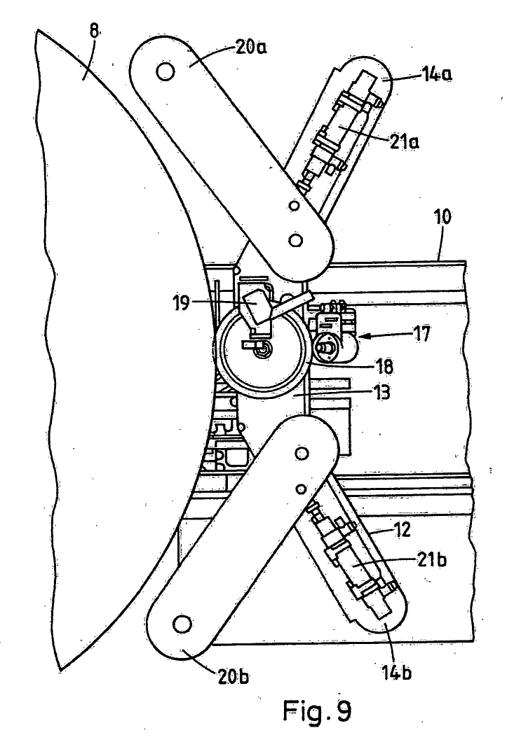

The edge cutting disc 18 is then caused to rotate and the paper reel 8 is rotated slowly once about its axis by rotating one of the rolls 9a, b (FIG. 9), with the result that an all-round cut is made just behind the end label through the circumferential packaging. 66 and the end part 36 consisting of the end label 64 and that part of the circumferential packaging 66 which is connected to it is separated off from the circumferential packaging. The spindle 33 remains in the position which it had assumed during unwinding of the positioning strip 27, so that a force directed slightly away from the end face always acts on the end part 36, and, as soon as it has been completely separated off, the end part 36 is held by the spindle 33 and is present a small distance in front of the end face.

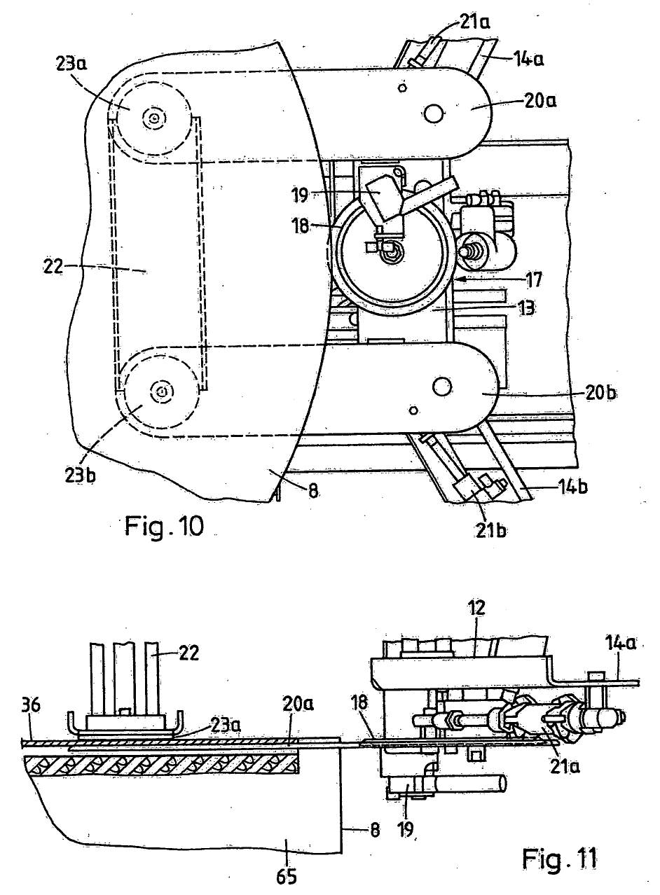

The gripper arms 20a, b are then folded out of their rest positions towards the axis of the paper reel 8 into horizontal positions of use in which they each lie between the end face and the end part 36. Thereafter, the clamping arm 22 is advanced parallel to the axis towards the end face until the clamping rams 23a, b press against the end part 36 at the height of the end regions of the gripper arms 20a; b so that said side part 36 is clamped between the gripper arms 20a, b and the clamping rams 23a; b (FIG. 10, 11). Thereafter, the cutting apparatus 7 is swivelled by means of the robot arm 2 over the stacking basket 35 and rotated so that the open side of the housing 10 faces downwards and the gripper arms 20a, b are folded back into their rest positions. Thereafter, the driver fingers 34 on the spindle 33 are folded forwards and the end part 36 is ejected into the stacking basket 35 by advancing the clamping arm 22.

Next, the remaining end part is separated from the circumferential packaging in an exactly corresponding manner and introduced into the stacking basket 35.

For removing the remaining lateral parts 67 of the circumferential packaging 66, the separation apparatus 38 is first moved from a starting position in the separation direction by moving the carriage 39 along the rail 37. When the mantle sensor 43 responds to the lateral part 67 and detects the edge of the paper reel which runs around the end face, travel is continued slightly more than the distance between said lateral part and the rear support roller 42b. The baseplate 40 is then advanced in the transverse direction until the support rollers 42a, b rest on the lateral part 67. This movement is controlled on the basis of the output signal of the distance sensor 44. The pre-cutting disc 47, the cutting discs 50a, b for loosening purposes and the plough 55 are then advanced, i.e. in each case moved in the transverse direction into a position for use. The movement of the separation apparatus 38 in the separation direction is then resumed, the rotating pre-cutting disc 47 making a preliminary cut which is about 0.4 mm deep, penetrates the lateral part 67 and also includes the outermost layers of the paper reel 65 which are adhesively bonded thereto (FIG. 14). The depth of the preliminary cut may also assume other values, but it is preferably not greater than 0.6 mm.

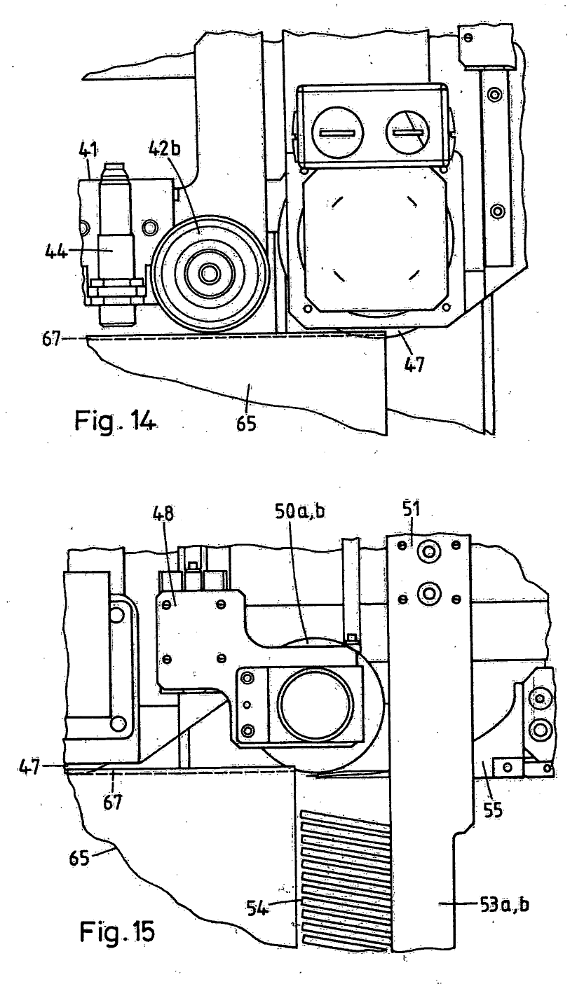

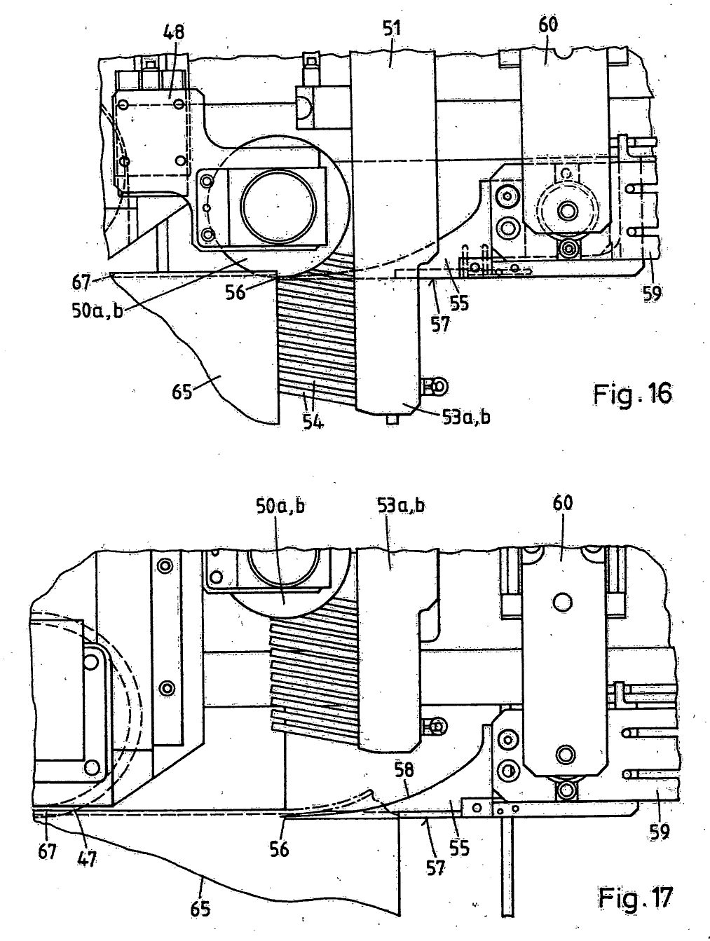

When the separation apparatus 38 is advanced further, the rotating cutting discs 50a, b for loosening purposes which are moved through their position for use also come into contact with the lateral part 66 at two starting points which are a distance apart laterally (FIG. 15) and each make a loosening cut which starts from the edge and is altogether between 2 mm and 40 mm, for example about 30 mm, long and between 0.2 mm and 0.8 mm, for example about 0.5 mm deep, so that it penetrates slightly deeper into the paper reel 65 than the preliminary cut of the pre-cutting disc 47. In the region between the loosening cuts, the otherwise very firm winding of the paper reel 65 is now relaxed. At the same time, the ends of the bristles 54, come up against the end face and are slightly compressed. By drawing back the carrier 51 with the brushes 53a, b, that region of the end face of the paper reel 65 which is located between the loosening cuts is subjected to a spreading force which acts radially outwards and by means of which the paper reel is loosened there and the layers cut through are slightly raised (FIG. 16).

The tip 56 of the plough 55, which is advanced slightly further in the transverse direction than the cutting edges of the pre-cutting disc 57 and of the cutting discs 50a, b for loosening purposes, now penetrates into the end face at an insertion point (FIG. 17). The resistance against this is only slight since only a few uncut layers of paper are present outside the hump 58 and the outer layers cut by the cutting wheels 50a, b for loosening purposes are additionally loosened by the brushes 53a, b. They therefore exert only a slight force on the plough 55 so that the sliding surface 57 does not press strongly against the boundary layer on which it rests and the boundary layer is not pressed in or damaged.

The exact positions in the transverse direction which are assumed by the pre-cutting disc 47 and the tip 56 of the plough 55 in the position for use relative to the baseplate 40 and hence relative to the support rollers 42a, b and via these relative to the outside of the lateral part 67 on which they roll determine that position of the insertion point which is of decisive importance for correctly carrying out the longitudinal cut, and determine the pre-cutting depth. Said positions are set by the electric drive 46 or the pneumatic pistons 62, 63. For this purpose, data on the respective type of packed paper reel 8 are read out from a database, for example the thickness of the packaging paper of which the circumferential packaging 66 consists and the number of layers and the thickness and possibly the strength of the paper of the paper reel 65. From these data, the positions of the pre-cutting disc 47 and of the plough 55 which are to be assumed relative to the support rollers 42a, b are then determined. The type of packed paper reel 8 has been read primarily from a barcode which is printed on a label stuck on in the case of each such paper reel.

After the cutting discs 50a, b for loosening purposes and the brushes 53a, b have been drawn back from their positions for use, the lateral part 67 is cut open by the plough 55 along a continuous straight separation line which follows a generating line by further advance of the separation apparatus 38 in the separation direction. The pressure on the plough 55 is never very great during this procedure since at least the strong lateral part 67 is cut through by the preceding pre-cutting disc 47 in advance along the separation line. The plough 55 therefore needs to break open only a few—generally two or three—of the layers of the paper reel 65 which lie directly outside the boundary layer, so that there is no great pressure of the sliding surface 57 on the boundary layer. Because the tip 56 is curved slightly upwards, there is also no danger that it penetrates into the boundary layer. Owing to its springy suspension, the plough 55 follows the boundary layer even when the distance thereof from the axis or the orientation thereof varies slightly, which often occurs. The boundary layer which is exposed by the longitudinal cut therefore remains undamaged so that the paper reel 65 can be prepared and used after removal of the cut-open lateral part 67, generally without removing further windings.

With the modified embodiment of the separation apparatus 38 (FIG. 18, 19) the removal of the lateral part 67 takes place in substantially the same manner. However, the positions of the pre-cutting disc 47 and of the plough 55 in the transverse direction are adjusted after evaluation of the image supplied by the camera 68. The field of view comprises, in the phase shown in FIG. 18, 19, just before the advance of the pre-cutting disc 47 and the plough 55, a piece of the end face of the paper reel 65 including a section of the edge bounding the same.

The image is evaluated by an image processing program which evaluates the exact position of the edge and also the thickness of the mantle 67 of the packaging on the basis of the different brightnesses of the background, of the packaging paper and of the paper reel 65—as a rule white paper. If this proves to be impossible owing to a coincidence, for example a flap of packaging paper hanging over the edge of the end face, the paper reel 65 is turned slightly by means of the rolls 9a, b and the process is repeated. Thereafter, the pre-cutting disc 47 and the plough 55 are advanced in the transverse direction by the drive 46 or the pneumatic piston 71 and the insertion point where the tip of the plough 55 penetrates into the end face and the pre-cutting depth are thus set. This has the advantage that no database is required and a packed paper reel which belongs to a new type not yet recorded can also be processed.

The paper reel 65 is loosened by turning it slightly by means of the rolls 9a, b, preferably in the unwinding direction, so that the pressure points at which the paper reel 65 rests on the rolls 9a, b are moved azimuthally over the lateral surface, which leads to loosening of the outermost layers of the paper reel 65. Consequently, the loosening cuts can be omitted and the cutting wheels for loosening purposes can be dispensed with, but the application of a spreading force by means of the brushes 53a, b to that region of the end face which surrounds the insertion point is supported by compressed air pulses from the compressed air nozzles thereof.

Many modifications of the method described as well as of the device are possible without departing from the scope of the invention. Thus, for example, two robot arms, each having a cutting apparatus, may be provided so that it is possible to remove the two end parts substantially simultaneously and to shorten the cycle time. The separation apparatus can be equipped exclusively with a compressed air nozzle or a plurality thereof for generating the spreading force. The inclination of the plough can be electrically adjustable in each case in both embodiments of the separation apparatus and can be changed in a program or sensor-controlled manner during the longitudinal cut. Cutting wheels for loosening purposes may always be present or may be absent, depending on requirements.

It is of course also possible to remove only the end parts in the manner according to the invention and to equip the device only with the components required therefor. It is, however, advantageous to carry out the separation of the end parts as well as the cutting open of the lateral part in a manner according to the invention and also to provide a device which is capable of carrying out both steps, especially since such a device can be designed to be very compact in the manner described.

### List of Reference Symbols

1 Base frame
2 Robot arm
3 Base
4 Pivot arm
5 Pivot arm
6 Joint
7 Cutting apparatus
8 Packed paper reel
9a,b Rolls
10 Housing
11 Carriage
12 Support profile
13 Middle piece
14a,b Extensions
15 Boom
16 Positioning unit
17 Edge cutting unit
18 Edge cutting disk
19 Detector
20a,b Gripper arms
21a,b Pneumatic pistons
22 Clamping arm
23a,b Rams
24 Shield
25 Slot
26 Winding roller
27 Positioning strip
28 Tip
29 Ring
30 Pins
31 Wedge
32 Guide strip
33 Spindle
34 Driver finger
35 Stacking basket
36 End part
37 Rail
38 Separation apparatus
39 Carriage
40 Baseplate
41 Scanning unit.
42a,b Support rollers
43 Mantle sensor
44 Distance sensor
45 Carrier
46 Electric drive
47 Pre-cutting disc
48 Carrier
49 Pneumatic piston
50a,b Cutting disc for loosening purposes
51 Carrier
52 Pneumatic piston
53a,b Brushes
54 Bristles
55 Plough
56 Tip
57 Sliding surface
58 Hump
59 Holder
60 Carrier
61 Carrier
62 Pneumatic piston
63 Pneumatic piston
64 End label
65 Paper reel
66 Circumferential packaging
67 Lateral part
68 Camera
69 Carrier
70 Electric drive
71 Pneumatic piston
72 Stop
73 Set screw

1. (canceled)

2. Method according to claim 56, wherein the entry point is in the centre of the end part.

3. Method according to claim 56, wherein for opening the end part at the entry point, a spindle is inserted through said end part.

4. Method according to claim 3, wherein after opening of the end part, the end part is raised from the end face of the paper reel in the region of the entry point by withdrawing the spindle.

5. Method according to claim 56, wherein the packaging is pierced by the positioning part at the edge of the end face and, in the locating position, the fix is present outside the packaging.

6. Method according to claim 5, wherein the fix is detected optically, electrically, magnetically or mechanically.

7. Method according to claim 5, wherein the knife is moved to the starting position along the positioning part and with mechanical contact with the same.

8. Method according to claim 56, wherein a force directed away from the end face acts on the end part while the circumferential cut is being made.

9. Method according claim 56, wherein the end part is held while the circumferential cut is being made and thereafter and is set down after the separation and removal.

10. Method according claim 56, wherein the packed paper reel is rotated about its axis while the circumferential cut is being made, whereas the knife is substantially stationary.

11. (canceled)

12. Method according to claim 56, wherein the preliminary cut is likewise guided along the separation line.

13. Method according to claim 56, wherein the preliminary cut has a depth of not more than 0.6 mm.

14. Method according to claim 56, wherein the type of packed paper reel is determined and, depending on this, data are read out from a database and the depth of the preliminary cut is set according to said data.

15. Method according to claim 56, wherein an image of a part of the exposed end face of the paper reel and of the lateral part is recorded by an electronic camera and the depth of the preliminary cut is set according to the result of an automatic evaluation of the image.

16. Method according to claim 56, wherein the paper reel is loosened at least in the region of the insertion point before insertion of the tip.

17. Method according to claim 16, wherein for loosening the paper reel at the edge bordering the end face in the region of the insertion point, at least one loosening cut is made which cuts through at least the lateral part of the packaging along a line starting from the edge.

18. Method according to claim 17, wherein the at least one loosening cut begins at a starting point of the edge which is offset along the edge relative to the insertion point.

19. Method according to claim 17, wherein two loosening cuts begin at starting points located on both sides of the insertion point, in such a way that the insertion point is located, preferably centrally, between the starting points.

20. Method according to claim 17, wherein the offset between the insertion point and the at least one starting point of a loosening cut is not more than 40 mm and preferably at least 10 mm.

21. Method according to claim 17, wherein the distance of the insertion point from the edge and the depth of the at least one loosening cut at the starting point are in each case between 0.2 mm and 0.8 mm.

22. Method according to claim 17, wherein the at least one loosening cut runs in the separation direction.

23. Method according to claim 17, wherein the at least one loosening cut on the surface of the lateral part has a length of between 2 mm and 40 mm in the separation direction.

24. Method according to claim 16, wherein for loosening the paper reel, the lateral part is subjected to a pressure directed at at least one pressure point substantially towards its axis, whereupon the pressure point is moved azimuthally, preferably in the unwinding direction of the paper reel.

25. Method according to claim 24, wherein the pressure is exerted by at least one roll on which the paper reel rests and the displacement of the pressure point occurs by rotation of the paper reel about its axis.

26. Method according to claim 57, wherein before insertion of the tip, parts of the exposed end face of the paper reel which are present at least radially directly outside the insertion point are subjected to a spreading force directed radially outwards.

27. Method according to claim 26, wherein the application of the spreading force is effected by friction against the end face of the paper reel.

28. Method according to claim 26, wherein the application of the spreading force is effected by an air jet directed towards the end face of the paper reel.

29. Device for carrying out the method according to claim 56, comprising a support apparatus for receiving the packed paper reel having an axis orientated in a longitudinal direction, comprising at least one cutting apparatus for separating off an end part of the packaging of the paper reel, which cutting apparatus comprises an edge cutting unit adjustable in the longitudinal direction, advanceable in a transverse direction approximately perpendicular thereto and suitable for making a circumferential cut running in a circular manner around the axis of the packed paper reel by means of a knife, and a positioning unit having a spindle which can be moved back and forth in the longitudinal direction, wherein the positioning unit comprises a flat positioning part with a detectable fix which can be advanced perpendicularly to the longitudinal direction towards the edge cutting unit, and the edge cutting unit has a detector for detection of the fix.

30. Device according to claim 29, wherein the positioning part is in the form of a positioning strip at the tip of which the fix is located.

31. Device according to claim 30, wherein the positioning strip is formed so as to be elastic and is straight in the relaxed state and the positioning unit has a drivable winding roller which is rotatable about a winding axis perpendicular to the longitudinal direction and by means of which winding roller the positioning strip can be unwound for advancing the fix and onto which the positioning strip can be wound again.

32. Device according to claim 29, wherein the detector is in the form of an optical, electrical, magnetic or mechanical sensor.

33. Device according to claim 29, wherein the spindle has spreadable driver fingers.

34. Device according to claim 29, wherein the knife of the edge cutting unit is in the form of a drivable edge cutting disc which is rotatable about an axis oriented in the longitudinal direction.

35. Device according to claim 29, wherein the edge cutting unit comprises at least one flat gripper arm which is movable between the end part and the end face of the paper reel in a plane perpendicular to the longitudinal direction, and a clamping arm movable back and forth parallel to the longitudinal direction for clamping the end part on the at least one gripper arm.

36. Device according to claim 35, wherein the edge cutting unit has at least two gripper arms which in each case are pivotable about a gripper axis parallel to the longitudinal direction and the clamping arm is displaceable in the longitudinal direction and carries two clamping rams, each of which projects towards one of the gripper arms.

37. Device according to claim 29, wherein the device has a base frame and at least one robot arm which carries the at least one cutting apparatus and which is mounted on the base frame so as to be pivotable about at least one pivot axis perpendicular to the longitudinal direction, preferably about at least one horizontal pivot axis and a vertical pivot axis.

38. Device according to claim 29, wherein the support apparatus comprises two horizontal rolls which are oriented in the longitudinal direction and arranged side by side a distance apart and at least one of which can be driven for rotation of the paper reel about its axis.

39. Device according to claim 29, wherein the device comprises a separation apparatus which, for cutting open a lateral part of the packaging of the paper reel, can be moved from a starting position in a separation direction parallel to the longitudinal direction and can be fetched back to the starting position, comprising a separating part with a tip pointing in the separation direction and a sliding surface which is adjacent to said tip and the position of which is adjustable parallel to a transverse direction normal to the separation direction, and comprising a pre-cutting unit located before the separating part in the separation direction and having a pre-cutting knife with a cutting edge parallel to the separation direction.

40. Device according to claim 39, wherein the position of the pre-cutting knife relative to the separating part is adjustable in the transverse direction.

41. Device according to claim 39, wherein the pre-cutting knife is in the form of a drivable pre-cutting disc parallel to the separation direction and to the transverse direction.

42. Device according to claim 39, wherein the separating part is in the form of a plough in which the sliding surface is curved in a convex manner towards the tip and which has, on the side opposite the sliding surface, a hump which starts from the tip and the distance of which from the sliding surface increases in a direction opposite to the separation direction.

43. Device according to claim 39, wherein the separation apparatus comprises a cutting unit for loosening purposes, having at least one drivable cutting disc for loosening purposes which is approximately parallel to the separation direction and to the transverse direction and is arranged in the region of the tip of the separating part at least in a position for use.

44. Device according to claim 43, wherein the at least one cutting disc for loosening purposes is offset laterally relative to the tip of the separating part, i.e. transversely to the separation direction and to the transverse direction.

45. Device according to claim 44, wherein the cutting unit for loosening purposes has two parallel cutting discs for loosening purposes which are arranged side by side a distance apart, while the tip of the separating part is located, preferably centrally, between them.

46. Device according to claim 43 wherein the cutting unit for loosening purposes is displaceable in the transverse direction relative to the separating part, in such a way that the at least one cutting disc for loosening purposes can be retracted from the position for use.

47. Device according to claim 39, wherein the separation apparatus comprises a spreading unit which is suitable for generating a spreading force directed outwards in the transverse direction.

48. Device according to claim 47, wherein the spreading unit has at least one friction surface pointing towards the separation direction, displaceable in the transverse direction and arranged in the region of the tip of the separating part in a position for use.

49. Device according to claim 48, wherein the spreading unit has at least two friction surfaces which are arranged side by side a distance apart in such a way that the tip of the separating part is located transversely to the separation direction, preferably centrally, between them.

50. Device according to claim 48, wherein the spreading unit has at least one brush having bristles which point substantially in the separation direction and the ends of which form the friction surface.

51. Device according to claim 43, wherein a friction surface is present in each case between a cutting disc for loosening purposes and the tip of the separating part.

52. Device according to claim 47, wherein the spreading unit has a compressed air nozzle pointing in the separation direction, displaceable in the transverse direction, arranged in the region of the tip of the separating part in a position for use and directed in the separation direction.

53. Device according to claim 39, wherein the separation apparatus comprises a carriage which is mounted on the base frame so as to be displaceable in the separation direction and opposite thereto, which carriage carries the separating part and all further units belonging to the separation apparatus and which has, for positioning in the transverse direction, support rollers which are suitable for rolling on the lateral part.

54. Device according to claim 53, wherein the separation apparatus carries an edge sensor for determining the position of the end face of the paper reel in the separation direction.

55. Device according to claim 39, wherein the device has an electronic camera preferably mounted on the separation apparatus and directed in the separation direction.

56. A method for at least partly unpacking a packed paper reel, comprising at least one of separating an end part of the packaging from a lateral part of the packaging and cutting open the lateral part of the packaging, wherein
the end part of the packaging, which part covers the end face thereof, is separated off by opening the end part at an entry point a distance away from its edge and determining from there a starting position on its edge and then separating the end part from a lateral part of the packaging by means of a knife by a circumferential cut beginning at the starting position and running just outside the end face, whereupon the end part is removed, wherein a flat positioning part having a detectable fix is introduced at the entry point and is advanced between the end part and the end face of the paper reel until the fix reaches a locating position in the region of the edge of the end face, whereupon the fix is detected there and, on the basis of its position, the starting position is established and the knife is placed at said starting position,
wherein, for cutting open the lateral part of the packaging, a separating part having a tip and a sliding surface adjacent thereto is inserted at an insertion point which is slightly within the lateral part on the exposed end face of the paper reel, with tip pointing towards the end face and sliding surface pointing towards the axis of the paper reel, and is guided longitudinally along a separation line to the opposite end face in a separation direction parallel to the axial direction, the sliding surface sliding over a boundary layer of the paper reel and layers present outside said boundary layer being cut through, and in that beforehand a preliminary cut which cuts at least partly through the lateral part from the outside is made from the exposed end face to the opposite end face.

57. The method of claim 56 further comprising:
unpacking a packed paper reel by separating the end part of the packaging from a lateral part of the packaging, and after exposure of the at least one end face of the paper reel by separation and removal of the corresponding end part, cutting open the lateral part of the packaging.

58. The method of claim 56 further comprising:
unpacking a packed paper reel by separating the end part of the packaging from a lateral part of the packaging.

59. The method of claim 56 further comprising:
unpacking a packed paper reel by cutting open the lateral part of the packaging.

60. A device for carrying out the method according to claim 56, comprising:
a separation apparatus for cutting open a lateral part of the packaging of the paper reel, the separation apparatus being movable from a starting position in a separation direction parallel to the longitudinal direction and returnable back to the starting position, the separation apparatus including:
a separating part with a tip pointing in the separation direction and a sliding surface which is adjacent to said tip and the position of which is adjustable parallel to a transverse direction normal to the separation direction, and
a pre-cutting unit located before the separating part in the separation direction and having a pre-cutting knife with a cutting edge parallel to the separation direction.
